(19) United States
(12) Patent Application Publication
(10) Pub. No.: US 2015/0048941 A1
(43) Pub. Date: Feb. 19, 2015

(54) EXCESSIVE-STOP ALERTS IN A WEB BASED ASSET TRACKING SYSTEM

(71) Applicant: LandAirSea Systems, Inc., Woodstock, IL (US)

(72) Inventors: Robert Wagner, Woodstock, IL (US); Vincent Lee, Houston, TX (US)

(73) Assignee: LandAirSea Systems, Inc., Woodstock, IL (US)

(21) Appl. No.: 13/965,970

(22) Filed: Aug. 13, 2013

(51) Int. Cl. G08B 25/10

(52) U.S. Cl. CPC G08B 25/10
USPC 340/539.13

(57) ABSTRACT

A geolocation server system and method monitors locations of mobile devices. The geolocation server system compares the locations against rules defining alert conditions. When an alert condition is satisfied, the geolocation server system generates an alert communication. The rules define excessive stop conditions and unauthorized stop conditions.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present disclosure is generally directed to systems for remote tracking of assets. More particularly, the present disclosure is directed to providing excessive-stop alerts in a web-based asset tracking systems.

Devices and systems have been developed which allow an asset to be tracked at a remote location. The asset, such as a delivery truck or automobile or any other mobile device or person, may be equipped with a position-tracking device. One example of a position tracking device is known as a GPS device and includes a radio receiver and processor for determining its location using received radio signals of the Global Positioning System. Location data are stored for subsequent retrieval or communication.

In addition to tracking devices, other systems and devices have been developed for making use of location data by a user. These include stand-alone, handheld devices and software applications operable in conjunction with hardware devices such as smartphones to produce a GPS receiver. These devices may display geolocation data such as latitude and longitude. In addition, these devices may combine the geolocation data with map data to produce a graphical image showing a determined location on a map. Additionally, aerial view information may be available so that the device may combine the determined location on an aerial view of the surrounding region and even combine the map information, the aerial information and the determined location.

In addition to having the geolocation information available at a handheld device, other systems have been developed to convey that geolocation information to a remote location. For example, it is known to install tracking software on a remotely located computing device such as a hosting server. The tracking software on the server communicates with client-side javascript files for display on a client device of maps with the geolocation information for a tracked device. Network functionality, including the internet, permits the display to be updated.

These known systems for remote tracking have met commercial success, for example, for tracking fleet vehicles or delivery or service vehicles or personnel. This success has created a need for additional features in systems and methods for monitoring and managing information produced by the use of such position tracking devices.

### BRIEF SUMMARY

By way of introduction only, a geolocation server system and method monitors locations of mobile devices. The geolocation server system compares the locations against rules defining alert conditions. When an alert condition is satisfied, the geolocation server system generates an alert communication. The rules define excessive stop conditions and unauthorized stop conditions. The disclosed method and system are beneficial for fleet vehicle managers who may want to receive alerts whenever an employed or contracted worker exceeds the time allotted to complete a project.

These and other advantages, aspects, and novel features of the present invention, as well as details of illustrated embodiments thereof, will be more fully understood from the following description and drawings.

### BRIEF DESCRIPTION OF THE DRAWINGS

FIG. 1 is a block diagram of a geolocation server system;

FIG. 2 is a flow diagram illustrating one embodiment of a method for the geolocation server system of FIG. 1;

FIG. 3 is a flow diagram illustrating one embodiment of a method for the geolocation server system of FIG. 1;

FIG. 4 is a screen shot illustrating operation of the geolocation server system of FIG. 1; and

FIG. 5 is a screen shot illustrating operation of the geolocation server system of FIG. 1.

### DETAILED DESCRIPTION OF THE DRAWINGS AND THE PRESENTLY PREFERRED EMBODIMENTS

Beyond merely tracking an asset, it is desirable to mine and manage the information about location of one or more assets. For example, the location information can give a user insight about the progress or activities of an asset or its user. In one example, a vehicle used for delivery or pickup of goods or passengers is expected to make scheduled or routine stops at specified locations, possibly on a set route or itinerary. In some circumstances, it is desirable to monitor the progress of the vehicle, for example to ensure that required progress on the itinerary is being made or to ensure that the journey has not been disrupted.

It is known to define a geo-fence to establish a virtual perimeter around a geographic area. A geo-fence may take the form of a radius around a point location on a map. A notification may be generated when a location-aware device crosses the perimeter of the geo-fence, either exiting or departing the fenced area. A text message or electronic mail message may be sent to notify an interested party or device.

Such a geo-fence only provides limited information, however. The notification may include only that an event has occurred, location data where the geo-fence was crossed and the time the geo-fence was crossed. Additional information may be derived, such as the time delay between successive crossings of the geo-fence. In a geo-fencing system, though, little further detail is available.

To provide additional information for a user, a system and method as disclosed herein provide a geolocation tracking device which collect current geolocation information for a person, vehicle or asset. The geolocation information can then be accessed by a user of a location tracking system via a web based user device operating under control of mapping software operating a web browser. The user device under control of the software has the ability to indicate real time location and historical location information, routes traveled, past and current speed and the number of stops for a journey.

Further, the system and method notify a user of the location tracking system whenever a vehicle, person or asset equipped with a location tracking device performs excessive stops within a designated area, or performs unauthorized stops outside a designated area. The application or software records data about each stop and can be set to replay each stop and its location to the user. An alert is sent to the user to advise of the stop or stops. Such a system and method allow the progress of the tracked asset to be automatically monitored and problems or deviations detected and alerted. This can allow quick intervention and trouble-shooting, to determine the reason for the excessive stops and take corrective action.

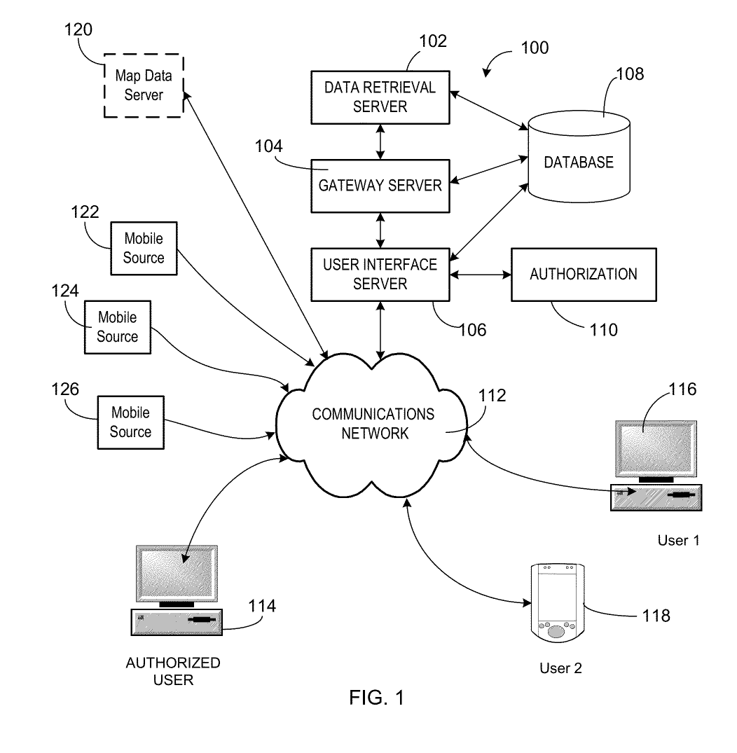

Referring now to the drawing, FIG. 1 is a block diagram of a geolocation server system 100. The geolocation server system 100 includes in the exemplary embodiment a data retrieval server 102, a gateway server 104, a user interface server 106, a database 108 and an authorization module 110. In other embodiments, additional components may be added to provide additional or different functionality or to improve efficiency to achieve other design goals. Moreover, the servers 102, 104, 106 may be combined into fewer devices where appropriate. Still further, the components of the geolocation server system 100 may be incorporated with other functional elements as part of a system that performs additional functions for additional customers, subscribers and clients. The functional breakdown of components of the geolocation server system 100 is intended to be exemplary only.

The geolocation server system 100 may be in data communication with a variety of other devices. These devices include in the illustrated example an authorized user device 114, a user device 116, a user device 118, a map data server 120, or mobile sources 122, 124, 126. Data communication between such devices and the geolocation server system 100 may be over a network or networks such as data communication network 112 and may include portions of the internet. Other devices and networks may communicate with the geolocation server system 100 as well.

In the geolocation server system 100, any suitable data processing system or systems may be used to implement the servers 102, 104, 106. A typical data processing system suitable for the functions described herein generally includes one or more processors which operate in conjunction with data and instructions stored in a memory. The instructions generally include computer readable program code stored on a computer readable medium such as semiconductor memory and magnetic or optical disk. The database 108 is one example of such a memory device. The database 108 stores data and instructions for access by the servers 102, 104, 106.

The stored data may originate locally with one of the servers 102, 104, 106 or may originate elsewhere and be received by one of the servers 102, 104, 106. For example, in the embodiment of FIG. 1, data may originate at authorized user device 114, user device 116, user device 118, map data server 120, or mobile sources 122, 124, 126. Similarly, data may be communicated from any of the servers 102, 104, 106 to any of these external destinations. Any suitable data communication technique may be employed for communication among the illustrated components. A standardized data transfer protocol such as transfer control protocol/internet protocol (TCP/IP) may be used, as one example. Moreover, communication channels may include any combination of wireless or wire line data communication. Further, any suitable data storage apparatus may be used to implement the database 108.

Within the geolocation server system 100, the servers 102, 104, 106, database 108 and authorization module 110 may communicate together as required for operation of the system 100. Accordingly, the geolocation server system 100 may include one or more data buses and other communication facilities. Further, for communication with external components, the geolocation server system 100 includes an interface for communication with one or more networks such as the network 112.

The authorization module 110 is configured to receive identification data from a user and to designate the user as an authorized user based on the received identification data. This designation may be conducted in any suitable manner, for example by comparing the identification data with a file of authorized users. The authorization module may be part of one of the servers 102, 104, 106 or may be implemented as a stand-alone data processing system with separate processor and memory as shown in FIG. 1.

In one example, the geolocation server system 100 communicates a web page forming a web portal to a remote device, such as the authorized user device 114. A web portal page may be accessed by directing a web browser on a data processing system such as the authorized user device 114 connected through the network 112 to the internet. One example of such a web portal page is provided at landairsea.com. An exemplary web portal page includes a text entry box and password entry box. A user who has an account established with the operator of the geolocation server system 100 may use the web portal page to enter security verification information such as a login identification and password. The authorization module 110 receives the security verification information from the user and authorizes the user to take further actions, including sharing geolocation data on remote devices. Any other suitable technique for establishing authorized access may be used as well or in addition.

The data retrieval server 102 is configured to receive geolocation data over a network such as the network 112 from one or more mobile sources. In the exemplary embodiment, of FIG. 1, the mobile sources 122, 124, 126 provide geolocation data on a substantially real-time basis. For example, each of the mobile sources 122, 124, 126 may be a self-contained location monitoring device and include a global positioning system (GPS) receiver; a control processor for determining the location of the mobile source based on received GPS data from GPS satellites; a terrestrial radio transceiver for communicating with the network 112; and a battery for powering the mobile source. An example of such a mobile source is the Silver Cloud Real Time Tracking System available from Land Air Sea Systems, Woodstock, Ill. This system determines location approximately once every second and transmits its data approximately every three seconds. It includes a cellular radio transceiver for communicating with a cellular radio network and thereby communicating with a server system. Other examples of mobile sources include suitably equipped handheld GPS devices, mobile phones and smart phones. Any device capable of tracking an asset or individual may be the source of the data received by the geolocation server system 100.

As noted, the geolocation data may be received on a substantially real-time basis. By a substantially real-time basis, it is meant that the geolocation data from the mobile sources 122, 124, 126 is updated in approximately the same time during which the mobile source is active to ensure that the location provided for the mobile source by the device is very accurate at any given time, depending on conditions. For example, when a mobile source detects that it is stationary, it may reduce its update frequency or the transmission of updated information in order to conserve battery life. Under different conditions, such as moving at a high rate of speed, the device may increase its update frequency in order that its location may be tracked with high accuracy, at about the same time the device is moving. Received geolocation data from a mobile source may be stored in the database 108.

The gateway server 104 is configured to communicate with a remote map server such as map data server 120. This communication is over any suitable communications network 112 such as the internet. The map data server 120 stores map data for access over a network. The stored map data may include map information for a specified mapped area or graphical display information such as an aerial view of a mapped area. The map data may be retrieved by providing a suitable request, such as address information or GPS coordinates. An example of a map data server is the system provided by Google Maps. Those of ordinary skill in the art are familiar with the requirements of data communication with Google Maps and other map data sources.

The gateway server 104 provides the GPS coordinates received from a mobile source by the data retrieval server 102 to the map data server 120 as a request over the network 112. The request may also specify the type of graphical display information to be retrieved, such as aerial view data. In response to the request, the map data server 120 provides the specified map data over the network 112. Map data including graphical display information are stored in the database 108. The gateway server 104 also reverse-geocodes the received GPS coordinates to determine a physical address for the location of the transmitting mobile source. The physical address is stored in the database 108.

Preferably, as updated GPS coordinates or other geolocation data are received by the data retrieval server 102, they are provided to the map data server 120 and updated map data is received and combined with the updated geolocation data. In this manner a graphical display of location of the mobile source which originated the geolocation data may be updated, substantially in real-time. This may permit an icon or other representation of the mobile source to be displayed on a video display along with the map data to convey a visual understanding of the geographical location of the mobile source and produce a graphical location display. As the mobile source moves, the icon moves in relation to features of the map data such as roads and structures. A highlighted line or other graphical feature may be displayed to show on the map past locations of the mobile source so that the progress of the mobile source may be visually tracked across the video display. If the user of the video display changes the view, such as by zooming in or zooming out or panning the view, the map data is appropriately updated and the position of the icon relative to the map data is adjusted accordingly so that the real-time geographical position is conveyed to update the graphical location display.

The user interface server 106 is configured to receive from an authorized user at the authorized user device 114 a request to share location information for a set of mobile sources such as the mobile sources 122, 124, 126. The set of mobile sources may be any number of mobile sources, from one to the number that are available. The request from the authorized user specifies the mobile sources to be tracked.

To provide additional information for an authorized user, a system and method have been developed to provide excessive stop alerts to the authorized user for one or more mobile sources. A GPS tracking device or other tracking device of a mobile source collects current GPS coordinates and relays multiple real time location data to a secure database such as the database 108. The location information for the mobile source is then accessed by the authorized user of the geolocation tracking system using web-based mapping software or other application. This software or other application has the ability to indicate the tracked mobile source's real time location and historical locations, routes taken, past and current speed and identify any stops made.

In addition, the application may be set to notify an authorized user whenever a tracked mobile source performs excessive stops within one or more predefined zones, areas or spaces. Further, the application may be able to notify the authorized user whenever a tracked mobile source performs unauthorized stops outside the one or more predefined zones, areas or spaces. The application may further be used to define the zones or areas or spaces of interest, the boundaries of which will trigger an alert.

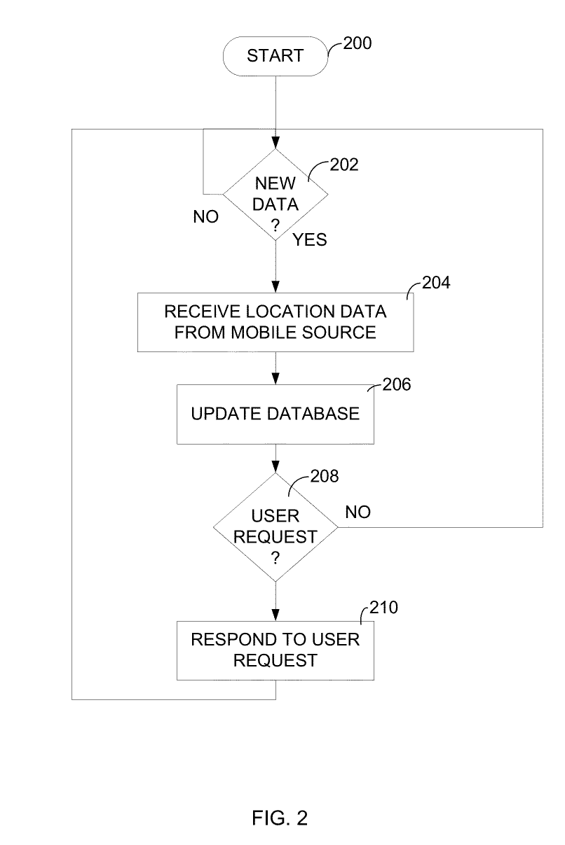

FIG. 2 is a flow diagram illustrating one embodiment of a method for the geolocation server system of FIG. 1. The method illustrates a process of collecting geolocation data from one or more mobile sources, received over a network at the geolocation server system. The collected geolocation data are processed, for example by the user interface server 106 of FIG. 1 to monitor location and travel of respective mobile sources over time. The method begins at block 200.

At block 202, the geolocation server system determines if new data has been received from a mobile source. New data may include a periodic or aperiodic communication over a network from the mobile source. In one example, a mobile source includes a GPS receiver, a processor and memory and a communication circuit. The processor from time to time determines geolocation data, such as latitude and longitude, for the mobile source. The mobile source may be attached to a vehicle or a person to track the location of the vehicle or person. The geolocation data may be stored in memory and from time to time be communicated to the geolocation server system. In one example, the communication circuit of the mobile source includes a cellular radio for communicating data over a cellular network to the geolocation server system. The time of reception of such communications at the geolocation server system may be generally random as the timing of the processor determining the geolocation data may vary and in addition, the timing of communication of the data may vary, depending on factors such as activity of the mobile source, battery conservation provisions and communication channel availability. Accordingly, the geolocation server system remains in a loop including block 202 until data is received.

When a communication with new geolocation data is received, control proceeds to block 204. The data from the mobile source is received and processed. For example, a communication packet may be decoded to obtain account information, identification information for the transmitting mobile source, the location data that is the subject of the communication and any other included information.

At block 206, the processed data is used to update the database of the geolocation server system. For example, if other data from the same mobile source has been previously received, the record for the mobile source will be appended with the newly received data.

Additional processing may be done. For example, at block 208, the geolocation server system may determine if an authorized user has set an alert for the mobile station. One example of an alert request from the authorized user is to provide to the authorized user an indication if the geolocation server system determines that the mobile source has performed excessive stops or unauthorized stops. If no request has been received, control returns to block 202 to await further data from a mobile source. Otherwise, the user request is processed and responded to at block 210.

A user request may include information about an asset to be tracked. The user request may further include information defining one or more geographic spaces through which the asset may move. Still further, the request may further include information defining an alert condition for movement of the asset relative to one or more of the geographic spaces. Responding to the user request, at block 210 and after geolocation data for the asset has been received and stored, my include comparing the received geolocation data stored in memory with the defined alert conditions. For example, the comparison may be done according to a set of one or more rules defined by the user. The rules may define that an alert should be generated for the user if the asset has stopped within a geographic space, or outside a geographic space, or stopped more than a permitted number of times of for longer than a permitted duration.

If a defined alert condition is met when comparing the geolocation data with the user-defined rules, responding to the user request may further involve communicating an alert. Communicating an alert may be done in any manner specified by the user. For example, the location server system may send a text message or an email message to a destination specified by the authorized user. This may be an account or mobile number of the authorized user or any other devices or individuals designated by the authorized user. Alternatively, if the authorized user or designated user is actively online with the geolocation server system, the alert may be provided over the network to the device of the authorized user. In one example, the authorized user may be actively viewing a web page that provides a dashboard display of system operation. A dashboard is a collection of graphical or textual information that displays data of interest to a user from a variety of different sources in high-level visuals like reports and charts. A dashboard display permits rapid visual monitoring of ongoing and changing conditions by a user. The geolocation server system may communicate the alert to the authorized user through the dashboard display.

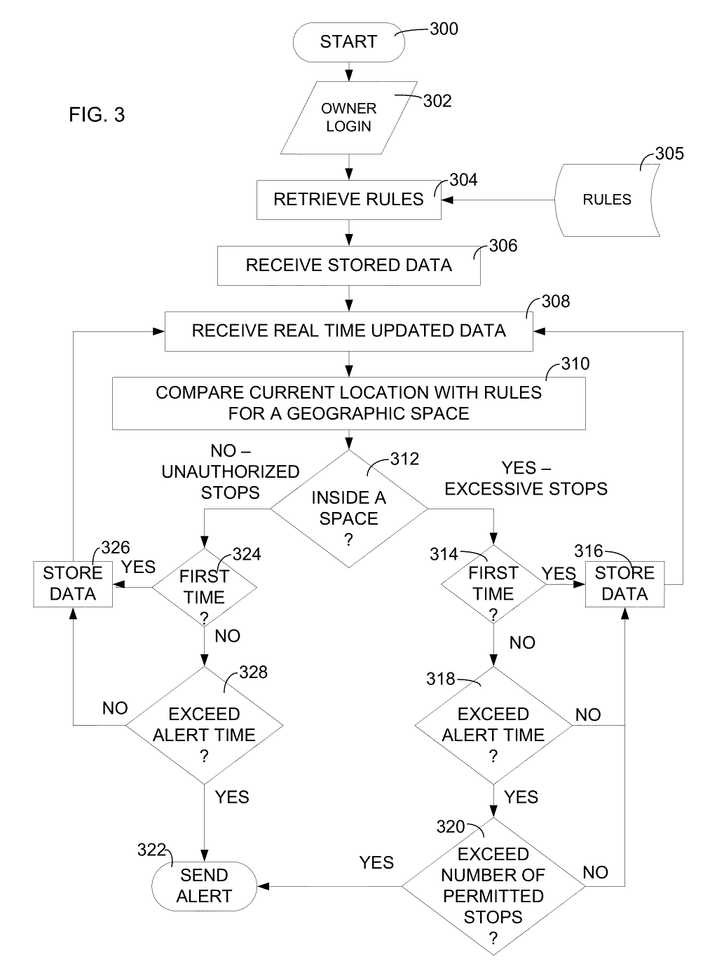

FIG. 3 is a flow diagram illustrating one embodiment of a method for the geolocation server system of FIG. 1. The method of FIG. 3 illustrates processing of received geolocation data and comparing the received geolocation data with user-defined rules for excessive stop and unauthorized stops. The procedure begins at block 300.

At block 302, an owner or other authorized user logs in to the geolocation server system. This may be done by providing appropriate authentication credentials. In alternative embodiments, the login procedure may be omitted.

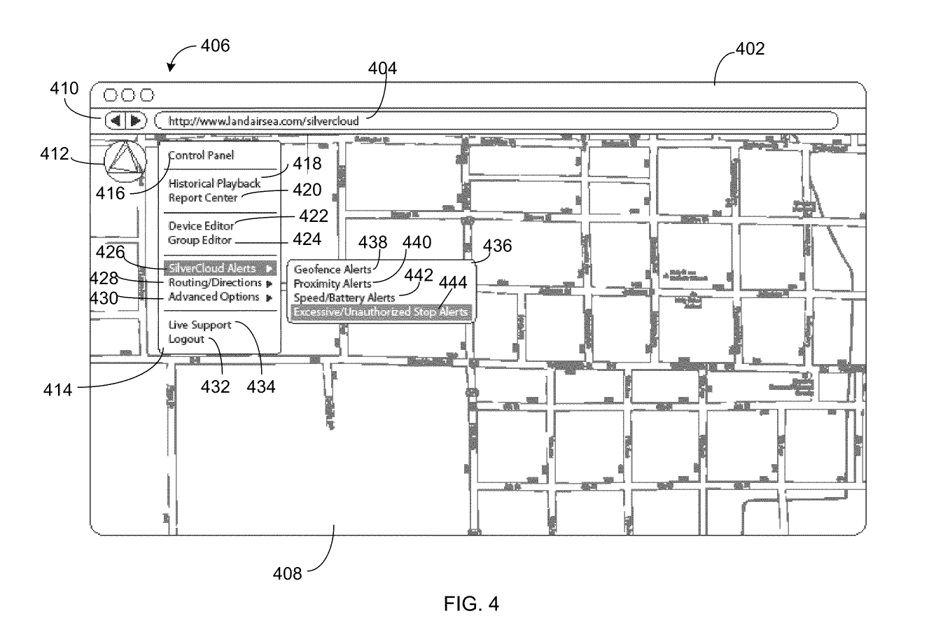

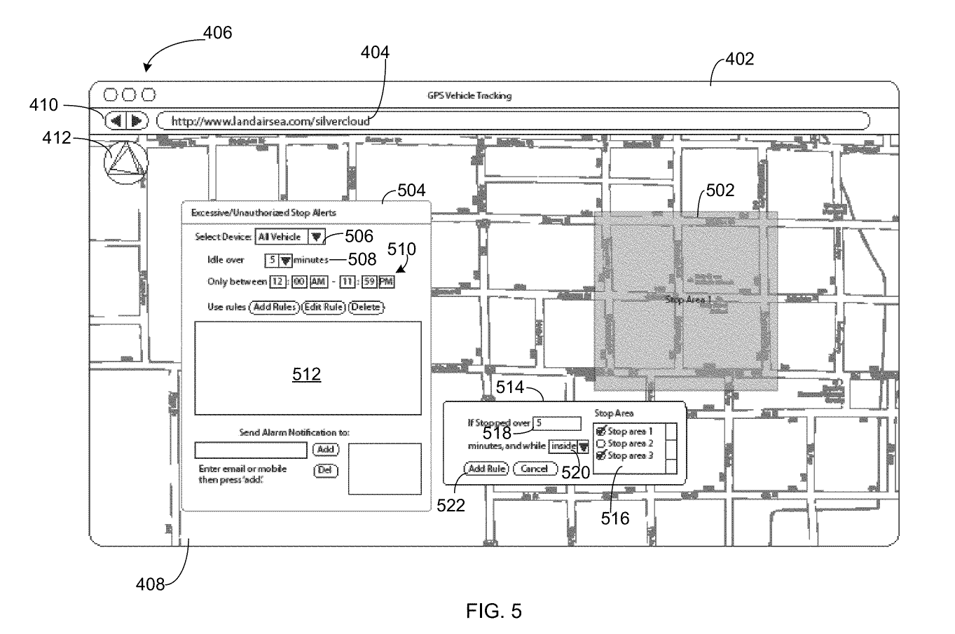

At block 304, data defining alert rules established by the authorized user are retrieved. In the example of FIG. 3, the rules are retrieved from a rules database 305. The rules define conditions or circumstances that will cause the geolocation server system to generate an alert. The rules also define the mobile source or device or user to which the rules apply. The rules also define the type of alert generated and its intended recipient or recipients. The rules may be established by the authorized user or any other party, in any convenient manner, such as by interacting with a web page or by an automated storage of rules data from a user or a device. Further examples of establishment of alert rules will be discussed in greater detail in conjunction with FIGS. 4 and 5.

After establishment of the rules, data defining the rules may be stored at the geolocation server system, such as in a database, for subsequent retrieval. Further, the rules may be subsequently edited or changed or even deleted under control of the authorized user or other party. In accordance with some embodiments described herein, some rules pertain to providing alerts when an excessive stop condition or an unauthorized stop condition has been detected by the geolocation server system. Other rules define locations where alert conditions should be applied. Other conditions may be detected and cause an alert to be generated as well.

At block 306, the geolocation server system retrieves stored data for one or more assets to be tracked. As described above in conjunction with FIG. 2, as an asset to be tracked determines its real time position, it may communicate that information to the geolocation server system for storage and subsequent processing. In block 306, stored data describing previous geolocation information for the asset is retrieved from storage.

At block 308, real time, updated data for the asset is received at the geolocation server system. As described above in conjunction with FIG. 2, as an asset to be tracked determines its real time position, position information may be communicated to the geolocation server system. This may be done periodically or aperiodically or from time to time. When the communicated position information is received, the geolocation server system responds to the data by processing the data to determine if an alert should be generated.

In the illustrated embodiment, an alert may be generated whenever a tracked asset performs excessive stops within a predefined space. Also, an alert may be generated whenever a tracked asset performs unauthorized stops outside of a predefined space. Details about the boundaries of the space, permitted number of stops and stop durations may be set by an authorized user either manually or automatically by transferring or uploading data defining the rules from a remote source. In the illustrated example, those details are part of the rules retrieved at block 304.

Thus in this example, at block 312, the geolocation server system determines if the current location received at block 308 indicates that the tracked asset is in a space defined by the rules retrieved at block 304. If the answer to the query of block 312 is affirmative, it may indicate an excessive stop condition. Control proceeds to block 314. At block 314, the geolocation server system determines if the current location inside the defined space is the first time the asset has been in the space. If so, at block 316, that information is stored as suitable data for subsequent use. Control then returns to block 308 to await receipt of additional location data from the asset.

If, at block 314, it was determined that the current time is not the first time the asset was in the defined space, at block 318, the geolocation server system determines the duration during which the asset has been in the defined space. This may be determined using the historical data retrieved at block 306. The duration may be compared with an alert time which is set, for example, by the rules retrieved at block 304. The alert time may set a maximum amount of time during which the asset may stop at any location within the space, or a cumulative amount of time the asset may spend within the space. If at block 318, the duration does not exceed the alert time, control proceeds to block 316, data are stored and control then proceeds to block 308 to await the next data from the asset.

If, at block 318, it was determined that the asset exceeded the alert time and an alert should be sent, control proceeds to block 320. There, it is determined if the asset has exceeded the permitted number of stops in the defined space. The permitted number of stops may be set, for example, by the rules retrieved at block 304. If the has not exceeded the permitted number of stops, control returns to block 316, data are stored and control then proceeds to block 308 to await the next data from the asset.

If, at block 320, it was determined that the asset did exceed the permitted number of stops, control proceeds to block 322 where an alert or alert communication is sent in accordance with the rules retrieved at block 304.

If, at block 312, it is determined that the tracked asset is not in a space defined by the rules retrieved at block 304 an excessive stop condition may exist. Control proceeds to block 324. At block 324, the geolocation server system determines if the current location outside the defined space is the first time the asset has been outside the space. If so, at block 326, that information is stored as suitable data for subsequent use. Control then returns to block 308 to await receipt of additional location data from the asset.

If, at block 324, it was determined that the current time is not the first time the asset was outside the defined space, at block 328, the geolocation server system determines the duration during which the asset has been outside the defined space. This may be determined using the historical data retrieved at block 306. The duration may be compared with an alert time which is set, for example, by the rules retrieved at block 304. The alert time may set a maximum amount of time during which the asset may stop at any location outside the space, or a cumulative amount of time the asset may spend outside the space. If at block 328, the duration does not exceed the alert time, control proceeds to block 326, data are stored and control then proceeds to block 308 to await the next data from the asset.

If, at block 328, it was determined that the asset exceeded the alert time and an alert should be sent, control proceeds to block 322. There, an alert or alert communication is sent in accordance with the rules retrieved at block 304.

FIG. 4 is a screen shot illustrating operation of the geolocation server system of FIG. 1. In particular, FIG. 4 shows a web page 402 that may be produced by a geolocation server system on a video display of a device of an authorized user. The web page 402 allows the authorized user to control the tracking operation and information display produced by the geolocation server system. The web page may be produced by any suitable web browser program or application, by directing the web browser to an address assigned to the web site that produces the web page. The web page may be interacted with in any conventional manner, including by means of a keyboard for text entry and by a pointing device such as a mouse or stylus or on a touch-sensitive display screen. The geolocation server system establishes a web interface, such as the web page 402 as one example, for communication with a user device of the authorized user. The web interface is operative to receive data defining requests for an alert from the user device, as will be described below.

The web page 402 includes an address bar 404, navigation controls 406 and a displayed image 408. The address bar 404 receives and displays a uniform resource locator or other address information identifying a network location of the web page 402. The navigation controls 406 include page forward and page back buttons 410 and a popup menu control 412. The page forward and page back buttons 410 allow easy navigation to a next-selected or previously-selected web page, as defined by the URL of web pages viewed by the web browser.

The displayed image 408 changes depending on the context of the web page. In the illustrated example, the context is display of a map showing location of one or more tracked assets on a map. The map includes street names, address data and other points of reference. In another context, the displayed image will change to display other pertinent features, such as identification information for tracked assets, an aerial view of geolocation information, or a combined map and aerial view.

The popup menu control 412 may be a hyperlink that, when activated, causes popup menu 414 to appear for further control of the tracking operation and information display. In the illustrated example, the popup menu control 412 is a graphical device. In other applications, the popup menu control may be part of a menu bar or ribbon that is displayed on a designated portion of the web page 402, such as at the top of the web page.

The popup menu 414 allows interaction by a user with the control and display functions of the geolocation server system and the web page 402. In the exemplary embodiment of FIG. 4, the popup menu 414 includes a control panel selector 416, a historical playback selector 418, a report center selector 420, a device editor 422, a group editor 424, an alert selector 426, a routing and directions selector 428, an advanced options selector 430, a help selector 434 and a logout selector 432.

The control panel selector 416 changes the view in the web page 402 from the map view displayed in FIG. 4 to a view allowing additional control over the operation of the geolocation tracking system and display of information by the user. The historical playback selector 418 allows control of the playback of the geographic location history of one or more tracked assets. Playback retrieves stored past geolocation information for the tracked assets and displays that information as a route traveled or list of locations and may be animated to show progress of the tracked assets on the map display. The report center selector 420 allows control of reports produced by the geolocation server system about tracking of one or more assets.

The device editor selector 422 allows control of information tracked and displayed about individual geolocation devices. An individual geolocation device may be attached to or associated with an asset to determine geolocation information for the asset and communicate that information in real time or near-real time to the geolocation server system. The group editor selector 424 allows control of grouping of multiple geolocation devices and subsequent control of display of tracking information of the grouped devices on a map display.

The alert selector 426 allows control of one or more alerts for one or more geolocation devices. As shown in the exemplary embodiment of FIG. 4, actuation of the alert selector 426 displays a popup submenu 436. In this example, the popup submenu 436 includes options to select a geofence alert control 438, a proximity alert control 440, a speed and battery alert control 442 and an excessive or unauthorized stop alert control 444.

The geofence alerts control 438 initiates a route which allows the user to define a boundary on a map display for one or more geolocation devices. When the geolocation server system receives geolocation information from one of the tracked geolocation devices indicating that the device has crossed the boundary, the geolocation server system will determine that an alert condition has occurred and generate a geofence alert. The user may specify the nature and content and destination of the geofence alert.

The proximity alert control 440 initiates a routine which allows the user to define a proximity condition around a geolocation on a map display for one or more geolocation devices. When the geolocation server system receives geolocation information from one of the tracked devices indicating that the device is at a location which is within a set proximity of a specified location, or that the device is at a location which exceeds a set proximity of a specified location, the geolocation server system will determine that an alert condition has occurred and generate a proximity alert. The user may specify the nature and content and destination of the proximity alert.

The speed and battery alert control 442 initiates a route which allows the user to define other alerts for one or more tracked devices. In one example, a speed alert may be set to provide an indication when a tracked device is travelling at a speed that is greater than a threshold speed such as 65 miles per hour. Similarly, a battery alert may be set to provide an indication when a the battery level of a geolocation device falls below a battery threshold, such as 20 percent state of charge. The geolocation server system will determine that a battery alert condition or a speed alert condition, for example, has occurred and generate a suitable alert. The user may specify the nature and content and destination of the generated alert.

Operation of the excessive or unauthorized stop alert control 444 will be described in greater detail below in conjunction with FIG. 5. The unauthorized stop alert control 444 initiates a routine which allows the user to define an alert condition for excessive stops by a tracked geolocation device or unauthorized stops by a tracked geolocation device.

The routing and directions selector 428 initiates a routine to allow a user to identify routing and provide directions from a current or specified location to a specified location of a tracked geolocation device. The advanced options selector 430 initiates a routine that provides access to additional control and display options. The help selector 434 provides access to user help information and the logout selector 432 ends authorized access to the geolocation server system.

FIG. 5 is a screen shot illustrating operation of the geolocation server system of FIG. 1. In particular, FIG. 5 illustrates the web page 402 of FIG. 4 after actuation of the excessive or unauthorized stop alert control 444. Upon actuation of the excessive or unauthorized stop alert control 444, the web page 402 in this embodiment displays controls for setting one or more alert conditions to provide to the user an alert upon the occurrence of an excessive stop condition or an unauthorized stop condition.

The user of an authorized device displaying the web page 402 may cooperate with the geolocation server system to notify the authorized user whenever a tracked mobile source or geolocation device performs excessive stops within one or more predefined zones, areas or spaces. Further, geolocation server system will notify the authorized user whenever a tracked mobile source or geolocation device performs unauthorized stops outside the one or more predefined zones, areas or spaces. The application may further be used to define the zones or areas or spaces of interest, the boundaries of which will trigger an alert.

Thus, in FIG. 5, the user has defined a geometric space on the map forming an alert space 502. In the illustrated example, the alert space 502 is rectangular, but any shape may be chosen. In one example, the user may engage a pointing device such as a mouse to interactively stretch vertices of the rectangle forming the alert space until a desired size or desired dimensions are set. Releasing or clicking the mouse will set the dimensions of the alert space. In another example, the user may use the mouse to set a circular diameter and interactively stretch the diameter to set the circle size and define the alert area. Other techniques may be used as well, such as by using multi-touch gestures on a touch screen display. In FIG. 5, the alert area 502 is labeled by the system as Stop Area 1.

The geolocation server system will receive the geometries entered by the user in relation to the map display 408. The geolocation server system will convert the entered geometries to either physical address data, such as street addresses, or longitude and latitude data. The converted alert zone data will be used by the geolocation server system to compare with position data communicated by a tracked device such as a mobile source or geolocation device. The geolocation server system will compare the boundaries of the alert zone 502 with the position data for the tracked device and decide whether an alert should be generated.

In the illustrated embodiment, the geographical resolution of the system may be quite fine. Thus, the alert area 502 in the example of FIG. 5 is drawn so that the alert area covers both sides of all streets within the alert area, plus a portion of private property adjacent to the streets. This can be used to determine if a tracked asset is parked on either side of the street at an address or even on the private property at the address.

The web page 402 in FIG. 5 also shows an alert menu 504 for setting alert parameters. The alert menu 504 includes a device selector 506, an idle time selector 508, a time limit selector 510, a rule definition area 512 and an alert contact definition area 524.

The device selector 506 in the illustrated embodiment includes a popup menu for selecting which mobile source or tracked asset is to be the subject of the alert. A user may select “all vehicles” or specify a vehicle by any suitable identification. The popup menu selections may be dynamically populated by interaction between the web browser, the authorized user's credentials and the geolocation server system so that a particular authorized user only sees displayed on the popup identifying information for tracked devices that user is authorized to control or monitor.

The idle time selector 508 is illustrated as a popup menu that allows a user to specify an idle time or stop time. In this embodiment, any time during which the vehicle is at rest for a duration greater than the idle time set by the idle time selector 508 is considered a stop. The idle time selector 508 establishes a threshold over which a stop is considered a stop that should be alerted. A minimum value, such as 5 minutes, may be set to filter out normal stops due to traffic flow, for example. Other idle time durations may be selected. Also, the idle time duration may be associated with geolocation information so that a stop of, for example, 60 seconds that would be expected in busy traffic or an area with many traffic signals and would not be alerted would generate an alert if occurring in a relatively rural area with no or few traffic signals. Knowledge of location of features that may cause unexpected stops, such as traffic signals or current traffic conditions, may be used along with the idle time selector to determine if a stop should be alerted. Thus, if information has been collected showing unexpected traffic congestion the actual idle time used to decide if a stop should be alerted may be artificially extended based on the unexpected traffic congestion. Alternatively, the nature of the alert generated may be modified if a stop exceeds the specified idle time.

The time limit selector 510 allows the authorized use to set time of day limits on when the excessive stop and unauthorized stop alerts conditions should apply. In the example, the time limits are 12:00 AM to 11:59 PM, meaning the alerts always apply. For a vehicle which is used partly for business and partly for personal use, for example, the user may instead choose to set the time limit selector 510 to only business hours. In another embodiment, days of the week or calendar days may also be specified using a selector similar to the time limit selector 510.

The rule definition area 512 allows a user to specify alert rules for the selected device and selected time period. In the illustrated embodiment, an alert rule definition area 514 becomes active for specifying an alert rule. The alert rule definition area 514 includes a stop area selector 516, a time limit selector 518, a geometrical descriptor 520 and a rule selector 522. The stop area selector in the illustrated embodiment is a group of check boxes allowing the user to select among alert areas specified by the user to which the alert should apply. The time limit selector 518 allows the user to specify a maximum time permitted for a stop before the alert condition becomes true. The geometrical descriptor 520 allows the user to select whether the alert condition applies when the tracked asset is inside or outside the alert area. An alert condition inside the alert area will be considered an excessive stop. An alert condition outside the area will be considered an unauthorized stop. By actuating the rule selector 522, the rule as defined by the rule definition area will be added to the set of rules for generating alerts for the user. A cancel selector is also available to cancel the rule before it is applied.

The alert contact definition area 524 allows the user to specify contact information for a destination of any alert generated by the geolocation server system. In the illustrated embodiment, a user may specify an email address to which an alert email may be sent over the internet or other network. Further, the user may specify a mobile telephone number to which a text message may be sent over a cellular network or other network. One or more destinations may be specified. In other embodiments, other types of alerts may be specified, such as an automated telephone call to a specified telephone number or an alphanumeric page to a pager.

FIG. 5 illustrates how a user may manually enter rule information for one or more alert conditions. Other alternatives may be used in addition or instead of a manual technique. For example, data defining rule information may be automatically uploaded and stored in a database. The data may, for example, be tabular data contained in a data file containing comma separated values (.csv) or tab separated values (.tab). Any suitable file in any suitable format may be used. For example, contractors may use project management software to schedule worker and equipment movement. The project management software may be a source of rule information such as expected location data, geo-fence definition data, distance data, time duration data and other data. For example, a system such as the geolocation server system 100 of FIG. 1 may provide an application programming interface (API) accessible over the communication network 112 through which such data defining rule information may be conveyed to the system. The API may provide communication between the communication network 112 and the user interface server 106 or another server system. In addition, the rule information may be associated with a particular mobile device, driver or route and used in a method such as the method of FIG. 3 to determine if excessive stop alerts or unauthorized stop alerts should be generated.

After defining the rules for the excessive stop alerts or the unauthorized stop alerts, either manually or automatically or both, the geolocation server system begins monitoring the tracked devices against the rules. This may be done in accordance with the method of FIG. 3 or any other suitable technique.

From the foregoing, it can be seen that the present disclosure provides an expanded system and method for tracking geographic location of one or more assets and responding to received location data for the tracked assets. A user may specify alert conditions which are compared with the tracked geographic location of the assets. Among other conditions, alerts may be set when excessive stops are detected and when unauthorized stops are detected. The user specifies rules which define the conditions to be alerted. The rules are compared on a real time basis with received location information for the tracked assets.

This system and method have many benefits to users of geolocation tracking systems. The method and system are beneficial for fleet vehicle managers who may want to receive alerts whenever an employed or contracted worker exceeds the time allotted to complete a project. For example, upon setting the alert area for stop alerts, a fleet manager, dispatcher or business owner will receive an email message or text message if a driver exceeds a specified amount of time at a designated location within a predefined area, where the driver has been tasked to complete a project or make a delivery. Having access to this information allows improved management of resources. For example, unexpected delays can be detected and responded to by a fleet manager. Fleet vehicle and delivery services may develop the opportunity to potentially fulfill a larger number of orders since drivers are providing services and delivering products in a more timely manner.

It is therefore intended that the foregoing detailed description be regarded as illustrative rather than limiting, and that it be understood that it is the following claims, including all equivalents, that are intended to define the spirit and scope of this invention.

1. A geolocation server system comprising:
a data retrieval server configured to receive geolocation data over a network from one or more mobile sources;
a gateway server configured to communicate with a remote map data server;
a database configured to store data including the received geolocation data and map data received from the map data server; and
a server system configured to receive from an authorized user a request for an alert, the request including data defining:
a mobile source of the one or more mobile sources to be tracked,
an alert time,
an alert zone, and
a rule defining an alert condition relating movement of the mobile source relative to the alert zone and the alert time,
the server system configured to communicate an alert communication to the authorized user when the alert condition is satisfied.

2. The geolocation server system of claim 1 wherein the server system is operative to compare received geolocation data for the mobile source with the alert zone to determine if the alert condition is satisfied.

3. The geolocation server system of claim 2 wherein the server system is operative to:
determine from the received geolocation data for the mobile source successive geographical positions of the mobile source;
determine from the successive positions of the mobile source and the alert zone movement of the mobile source relative to the alert zone.

4. The geolocation server system of claim 3 wherein the server system is operative to:
determine an unauthorized stop alert condition is satisfied when the successive positions of the mobile source indicates that the mobile source has stopped outside the alert zone for a time period exceeding the alert time.

5. The geolocation server system of claim 3 wherein the server system is operative to:
determine an excessive stop alert condition is satisfied when the successive positions of the mobile source indicates that the mobile source has stopped inside the alert zone for a time period exceeding the alert time.

6. The geolocation server system of claim 1 wherein the server system is configured to receive from the authorized user one or more data files including data defining alert conditions.

7. The geolocation server system of claim 6 wherein the server system is configured to receive one or more data files including one or more alert times, one or more alert zones and one or more rules defining alert conditions.

8. The geolocation server system of claim 6 wherein the server system is configured to establish a web interface for communication with a user device of the authorized user, the web interface operative to receive data defining the request for an alert from the user device.

9. The geolocation server system of claim 1 wherein the server system configured to communicate one of a text message and an electronic mail message as the alert communication.

10. A method comprising:
at a server system,
receiving information about an asset to be tracked;
receiving information defining one or more geographic spaces through which the asset may move;
receiving information defining alert conditions for movement of the asset relative to the one or more geographic spaces;
from time to time, receiving geolocation data for the asset;
storing the received geolocation data in a memory;
comparing the geolocation data with the defined alert conditions; and
communicating an alert when a defined alert condition is met by the comparison with the geolocation data.

11. The method of claim 10 wherein receiving information defining one or more geographic spaces comprises:
at the server system,
providing data for a user interface to a client device;
receiving map coordinate data from the user interface of the client device.

12. The method of claim 10 wherein receiving information defining one or more geographic spaces comprises:
at the server system,
providing data for a user interface to a client device;
receiving from the user interface geometrical data drawn on the user interface by a user of the client device, the geometrical data defining the one or more geometric spaces relative to a map image displayed on the user interface.

13. The method of claim 10 wherein receiving information defining alert conditions comprises:
at the server system,
receiving from a client device data defining an alert time; and
receiving from the client device data defining a respective alert rule for a respective geographic space.

14. The method of claim 13 wherein receiving data defining an alert time comprises receiving a maximum time duration.

15. The method of claim 14 wherein receiving a respective alert rule comprises:
receiving from the client device an unauthorized stop rule to generate an alert when the asset to be tracked stops for a duration that exceeds the alert time at a location outside a respective geographic space.

16. The method of claim 14 wherein receiving a respective alert rule comprises:
receiving from the client device an excessive stop rule to generate an alert when the asset to be tracked stops for a duration that exceeds the alert time at a location inside a respective geographic space.

17. A geolocation server system comprising:
a data retrieval server configured to receive geolocation data over a network from one or more mobile sources;
a database configured to store data including the received geolocation data and data defining excessive stop conditions and unauthorized stop conditions for mobile sources; and
a server system in data communication with the data retrieval server and the database, the server system configured to process the received geolocation data for comparison with the data defining the excessive stop conditions and unauthorized stop conditions for the mobile sources and to generate an alert communication upon the occurrence of an excessive stop condition or an unauthorized stop condition for a mobile sources.

18. The geolocation server system of claim 17 wherein the server system is further configured to compare a current location of a particular mobile source with a region defined by the data defining excessive stop conditions and unauthorized stop conditions to determine if the particular mobile source is inside a define region or outside the defined region.

19. The geolocation server system of claim 17 wherein the server system is further configured to determine a time duration for the particular mobile source inside the defined region or outside the defined region and to send an alert communication based on comparison of the time duration and the data defining excessive stop conditions and unauthorized stop conditions for mobile sources.

20. The geolocation server system of claim 17 wherein the server system is configured to receive from an authorized user data defining the defining excessive stop conditions and unauthorized stop conditions for mobile sources including receiving the data through a web interface or receiving the data through an application programming interface.
